(19) United States
(12) Patent Application Publication
(10) Pub. No.: US 2021/0365068 A1
(43) Pub. Date: Nov. 25, 2021

(54) SLIDABLE KEYBOARDS

(71) Applicant: Hewlett-Packard Development Company, L.P., Spring, TX (US)

(72) Inventor: Dong Ryul Cha, Spring, TX (US)

(73) Assignee: Hewlett-Packard Development Company, L.P., Spring, TX (US)

(21) Appl. No.: 16/980,900

(22) PCT Filed: Jun. 8, 2018
(86) PCT No.: PCT/US2018/036693

§ 371 Date: Sep. 15, 2020

(51) Int. Cl. G06F 1/16

(52) U.S. Cl. CPC G06F 1/1624; G06F 1/1679; G06F 1/1662

(57) ABSTRACT

In example implementations, an electrical device is provided. The electrical device includes a housing and a slidable keyboard. The slidable keyboard is movably attached to the housing via a ball bearing rail system. The ball bearing rail system includes a mechanical stop to control a distance that the slidable keyboard can open to access a set of electrical components. A latch is coupled to the slidable keyboard to engage a member in the housing when the slidable keyboard is in a closed position.

### BACKGROUND

Laptop computers are portable computing devices. The laptop computer provides the convenience of a full desktop computer, but packaged in a portable form factor that allows a user to travel with the laptop computer. The laptop computer may include a display and input/output devices combined into a single housing.

### BRIEF DESCRIPTION OF THE DRAWINGS

FIG. 1 is a block diagram of an example electronic device with a slidable keyboard;

FIG. 2 is an isometric view of an example ball bearing rail system of a slidable keyboard;

FIG. 3 is an isometric view of an example outer rail with an example mechanical stop of the slidable keyboard;

FIG. 4 is a cross-sectional front view of the example ball bearing rail system of the slidable keyboard;

FIG. 5 is a view of an example inner bottom side of a keyboard housing having an example outer rail;

FIG. 6 is a view of an example inner side of the slidable keyboard having an example inner rail;

FIG. 7 is a front view of an example outer side of a bezel having an example latch of the slidable keyboard;

FIG. 8 is a front view of an example inner side of the bezel having the example latch of the slidable keyboard;

FIG. 9 is a top cross-sectional view of the example latch of the slidable keyboard; and

FIG. 10 is a block diagram of an example electronic device with a slidable keyboard.

### DETAILED DESCRIPTION

Examples described herein provide a sliding keyboard for laptop computers. The housing of the laptop computers may not be able to provide easy access to upgrade electrical components of the laptop computer. For example, desktop computers may have housings that can be opened with easy access to a variety of the different electrical components within the desktop computer. In contrast, a laptop computer may have many electrical components that are completely enclosed inside of the housing and use tools to remove portions of the housing to access the electrical components.

Examples herein provide a sliding keyboard that provides easy access to upgradeable electrical components of the laptop housing. The sliding keyboard may include mechanical features that provide an efficient sliding mechanism with a maximum amount of stability. In other words, the sliding keyboard can be firmly secured when the sliding keyboard is closed and feel sturdy under the weight of a user's hands when closed.

In addition, the sliding keyboard can be stopped after opening a predefined amount. For example, the sliding mechanism may have a stop feature to control an open area of the mother board containing upgradeable electrical components.

The mother board may have an area to correspond to the area opened by the sliding keyboard. For example, the mother board may arrange the upgradeable electrical components in a horizontal row within a space that corresponds to a size of the opening creating by the sliding keyboard. The housing and the motherboard may also enclose important electrical components such that access to the important electrical components is blocked when the sliding keyboard is opened.

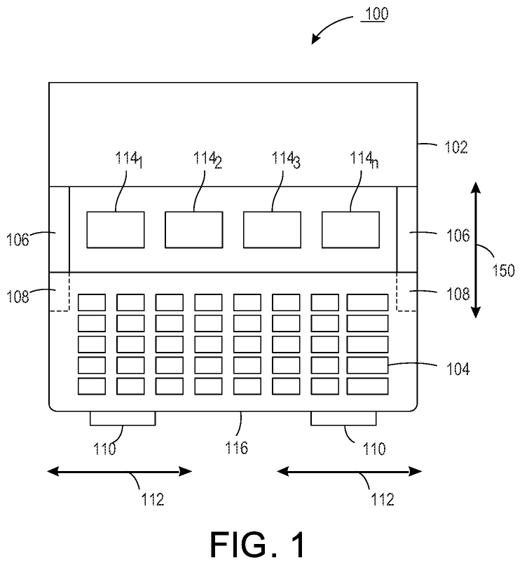

FIG. 1 illustrates a block diagram of an example electronic device 100 having a slidable keyboard 104. The electronic device 100 may be part of a laptop computer or other type of portable computing device.

In one example, the electronic device 100 may include a housing 102 that encloses a plurality of electrical components 114₁-114ₙ (hereinafter also referred to individually as an electrical component 114 or collectively as electrical components 114). Some of the electrical components 114 may be user upgradeable electrical components that can be accessed by opening the slidable keyboard 104.

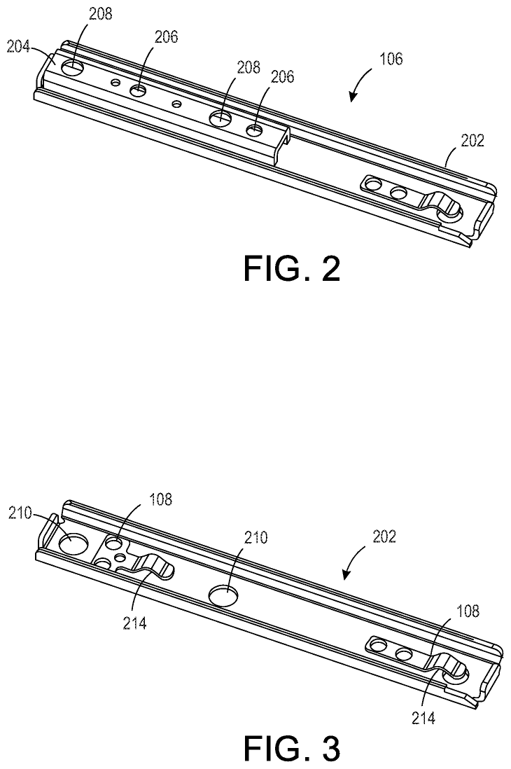

In one example, the slidable keyboard 104 may be movably attached to the housing 102 via a ball bearing rail system 106. The ball bearing rail system 106 may allow the slidable keyboard 104 to move horizontally up and down (e.g., closer to a display and farther away from the display) as shown by an arrow 150. Examples of the ball bearing rail system 106 are illustrated in FIGS. 2-4 and discussed in further details below.

In one example, electronic device 100 may include two ball bearing rail systems 106 that are located on opposite sides of the housing 102. For example, the ball bearing rail systems 106 may be located on a left side and a right side of the housing 102 near the left edge and right edge of the housing 102.

The slidable keyboard 104 may move via the ball bearing rail system 106 to move into an open position, as illustrated in FIG. 1. In the open position, the electrical components 114 that are intended by the manufacturer to be user upgradable may be accessed for replacement. When the slidable keyboard 104 is moved into a closed position, the slidable keyboard 104 may cover the electrical components 114.

In one example, the ball bearing rail system 106 may include a mechanical stop 108 (shown in dashed lines beneath the slidable keyboard 104 and inside of the housing 102). The mechanical stop 108 may be coupled to a portion of the ball bearing rail system 106. The mechanical stop 108 may control a distance that the slidable keyboard 104 may travel along the ball bearing rail system 106. For example, without the mechanical stop 108, the slidable keyboard may keep moving along the ball bearing rail system 106 and detach from the housing 102.

The mechanical stop 108 may also provide a tactile feedback to the user that the slidable keyboard 104 has reached the fully open position. Thus, the user may not try to pull the slidable keyboard 104 further, thereby avoiding damaging the slidable keyboard 104 or the ball bearing rail system 106. Examples of the mechanical stop 108 are illustrated in FIG. 3 and discussed in further details below.

In one example, the electronic device 100 may include a latch 110 coupled to a bezel 116 of the slidable keyboard 104. The electronic deice 100 may include a pair of latches 110 that are located on opposite ends on a front side of the bezel 116, as illustrated in FIG. 1. In one example, the latch 110 may move horizontally, as illustrated by an arrow 112. The latch 110 may move horizontally to move into a locked or unlocked position.

For example, the latch 110 may be moved to engage or disengage from a member in the housing 102 and located below the slidable keyboard 104. The member (illustrated in FIGS. 8 and 9) may be located adjacent to the latch 110. The latch 110 may engage the member to lock the slidable keyboard 104 in a closed position. The latch 110 may be moved horizontally to disengage from the member to release the slidable keyboard 104 from the closed position and allow the slidable keyboard 104 to be moved into an open position, as illustrated in FIG. 1.

In one example, the latch 110 may be spring loaded. As a result, when the latch 110 is moved horizontally to disengage the member, the latch 110 may automatically return to a default position. In addition, when the latch 110 is moved against the member, the latch may automatically engage the member to lock the slidable keyboard 104 in the closed position.

FIG. 2 illustrates an example of the ball bearing rail system 106. In one example, the ball bearing rail system 106 may include an outer rail 202 and an inner rail 204. The inner rail 204 may be shorter in length than the outer rail 202. For example, the inner rail 204 may be approximately half the length of the outer rail 202. The inner rail 204 may also be shorter in width than the outer rail 202 and fit inside of the outer rail 202. Said another way, the inner rail 204 may be narrower than the outer rail 202.

In one example, the inner rail 204 may include openings 206. The openings 206 may provide a hole to pass through a mechanical coupling (e.g., a screw). The inner rail 204 may be coupled to the slidable keyboard 104 via a mechanical coupling (e.g., a screw) through the openings 206.

The inner rail 204 may also include openings 208. The openings 208 may receive a portion of the mechanical stop 108. When a portion of the mechanical stop 108 catches the opening 208, the inner rail 204 may not be able to move any further. Examples of the portion of the mechanical stop 108 are discussed in further details below.

FIG. 3 illustrates an example of the outer rail 202. In one example, the outer rail 202 may include openings 210. The openings 210 may be used to couple the outer rail 202 to the housing 102 via a mechanical fastener (e.g., a screw).

The outer rail 202 may also include the mechanical stops 108. The outer rail 202 may include two mechanical stops 108. One of the mechanical stops 108 may limit the movement of the slidable keyboard 104 in the opening direction (e.g., away from the display or in a direction to expose the electrical components 114). A second one of the mechanical stops 108 may set the closed position of the slidable keyboard 104.

In one example, the mechanical stop 108 may include a raised portion 214. The raised portion 214 may have a gently sloped surface and be tensioned or spring loaded. The gently sloped surface may allow the corresponding openings 208 in the inner rail 204 to slide over the raised portion 214 and “catch” the raised portion. In addition, the gently sloped surface may allow an edge of the corresponding opening 208 to push the raised portion 214 down as the edge moves against the raised portion 214. Thus, the raised portion 214 may be moved below the corresponding opening 208 to “unlock” the inner rail 204 and allow the inner rail 204 to move freely again. The raised portion 214 may be a protruding member in that the raised portion 214 “protrudes” through a corresponding opening 208 in the inner rail 204.

To illustrate, inner rail 204 may slide against the raised portion 214 in an opening direction. When the raised portion 214 encounters a corresponding opening 208, the raised portion 214 may “click” into the opening 208. In addition to controlling the amount of movement of the slidable keyboard 104, the raised portion 214 provides a tactile feedback to a user that the slidable keyboard 104 is fully opened or closed.

In one example, when the slidable keyboard 104 is moved in an opposite closing direction, a slight force applied against the raised portion 214, may cause the raised portion 214 to move downward below the opening 208. The slidable keyboard 104 may then move again into the closed position until the raised portion 214 of the second one of the mechanical stops 108 “clicks” into a corresponding opening 208 of the inner rail 204.

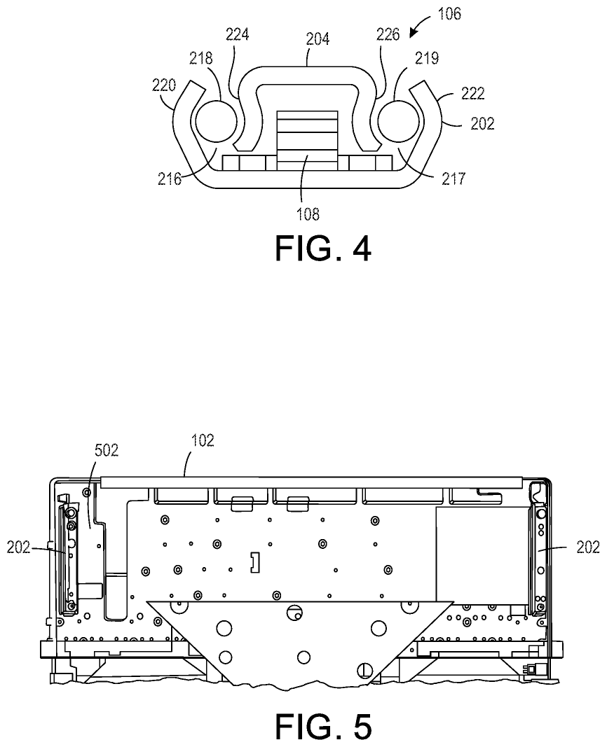

FIG. 4 illustrates a front cross-sectional view of the ball bearing rail system 106. In one example, the outer rail 202 may include a left wall 220 and a right wall 222. The left wall 220 and the right wall 222 may be slightly curved. The inner rail 204 may include a left wall 224 and a right wall 226. The left wall 224 and the right wall 226 may also be slightly curved.

The left wall 220 and the left wall 224 may create a first volume 216. The right wall 222 and the right wall 226 may create a second volume 217. A first ball bearing 218 may be located in the first volume 216 and a second ball bearing 219 may be located in the second volume 217. The first ball bearing 218 may be fit inside of the curves of the left wall 220 and the left wall 224 and the second ball bearing 219 may be fit inside of the curves of the right wall 222 and the right wall 226.

The ball bearings 218 and 219 may have dimensions (e.g., a volume or a diameter) that is approximately equal to a volume or a diameter measured between the curves of the walls 220 and 224 and walls 222 and 226. The ball bearings 218 and 219 may allow the inner rail 204 to move smoothly against the outer rail 202. The ball bearings 218 and 219 also provide a stable and sturdy movement of the slidable keyboard 104. In other words, the ball bearings 218 and 219 may allow the slidable keyboard 104 to move smoothly without rattling, feeling loose, or getting stuck.

FIG. 5 illustrates a view of an inner bottom side 502 of the housing 102. As illustrated in FIG. 5, the outer rail 202 may be located on the inner bottom side 502 of the housing 102. In one example, the outer rail 202 may be mechanically coupled along the left and right sides of the housing 102. In other words, two outer rails 202 may be positioned on opposite sides or ends from one another on the inner bottom side 502 of the housing 102.

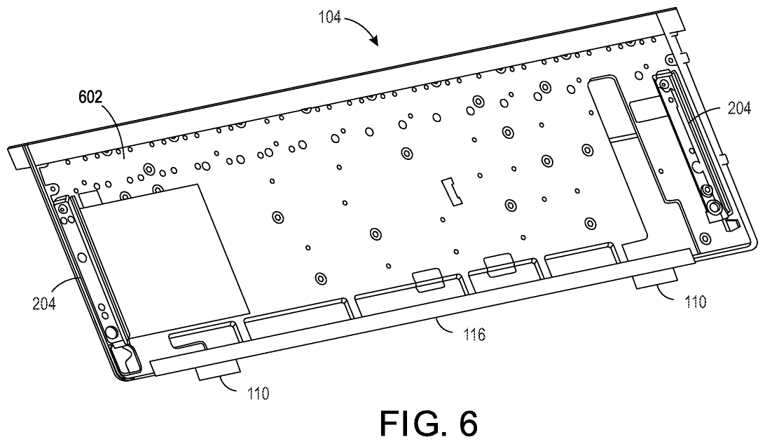

FIG. 6 illustrates a view of an inner side 602 of the slidable keyboard 104. The inner rail 204 may be located on the inner side 602 of the slidable keyboard 104. The inner rail 204 may be coupled to the outer rail 202 via the ball bearings 218 and 219, as described above. The inner rail 204 may be positioned on the inner side 602 of the slidable keyboard 104 at a location that corresponds to the location of the outer rail 202 on the inner bottom side 502 of the housing 102. In other words, the inner rail 204 may be positioned on the inner side 602 of the slidable keyboard 104 such that the inner rail 204 is aligned with the outer rail 202 and can fit inside of the outer rail 202, as described above.

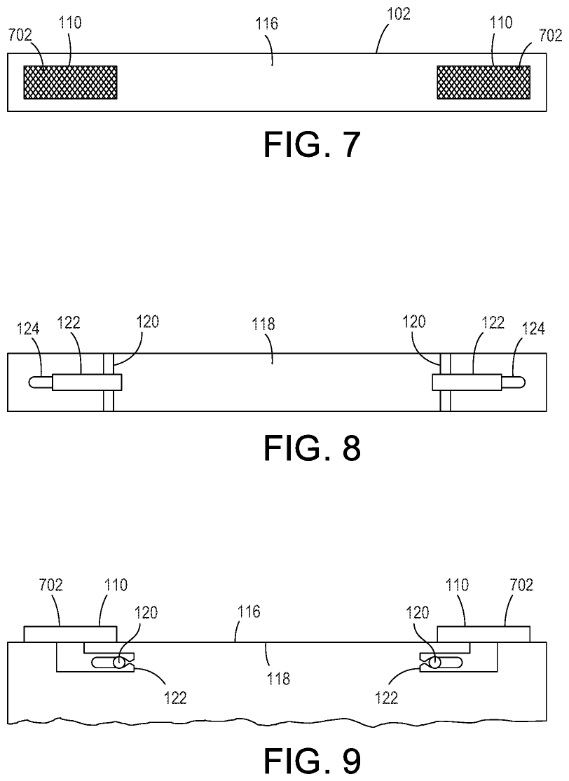

In one example, the front bezel 116 of the slidable keyboard 104 may also include the latch 110, as discussed above. FIGS. 7-9 illustrate various different views of the latch 110 on the front bezel 116 of the slidable keyboard 104.

FIG. 7 illustrates a front view of the latch 110 on the outer side of the bezel 116. The outer side of the bezel 116 may be a side that faces a user. As discussed above, the bezel 116 may include a pair of latches 110 on opposite ends of the bezel 116.

The latch 110 may include a front face 702 on the outer side of the bezel 116. The front face 702 may be textured to provide a non-slip surface that can be easily gripped. The texture of the front face 702 may be applied as a separate layer or molded directly into the front face 702. For example, a non-stick material may be applied to the front face 702, or the front face 702 may be molded with an irregular or rough surface to provide a non-slip surface.

FIG. 8 illustrates a front view of an inner side 118 of the bezel 116. The bezel 116 may include a horizontal slot or slotted opening 124. The slot may be wide enough to allow for horizontal movement of the latch 110. In one example, the latch 110 may include tensioned prongs 122 that engage a member 120.

In one example, the member 120 may be a fixed post or cylinder. The member 120 may be coupled to, or formed, as part of the inner bottom surface 502 of the housing 102. The member 120 may be located adjacent to the tensioned prongs 122 near the inners side 118 of the bezel 116.

FIG. 9 illustrates a top view of the latch 110. FIG. 9 provides a view of the tensioned prongs 122 of the latch 110. The prongs 122 may engage the member 120 to lock the slidable keyboard 104 in a closed position. The latch 110 may be moved horizontally via the front face 702 to disengage the tensioned prongs 122 from the member 120. When the tensioned prongs 122 are disengaged from the member 120, the slidable keyboard 104 may be move into an open position.

Although one example of the latch 110 is illustrated in FIGS. 7-9, it should be noted that other types of latches may be deployed that are within the scope of the present disclosure. For example, any moving mechanical mechanism that can securely lock the slidable keyboard 104 in a closed position may be deployed.

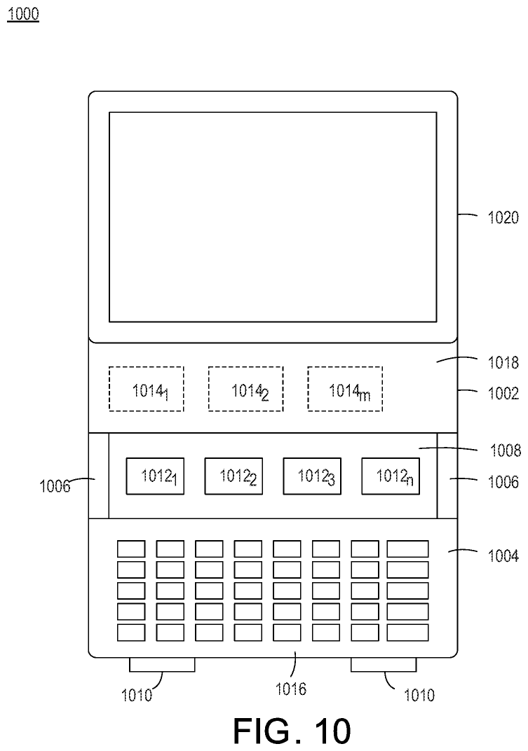

FIG. 10 illustrates an example of an electronic device 1000 with a slidable keyboard 1004. The electronic device 1000 may be a laptop computer, or any other portable computing device. In one example, the electronic device 1000 may include a keyboard housing 1002 and a display housing 1020. The display housing 1020 may be movable coupled to the keyboard housing 1002 (e.g., in a clamshell housing for laptop computers).

In one example, the electronic device 1000 may include a slidable keyboard 1004 that is movably coupled to the keyboard housing 1002. In one example, the slidable keyboard 1004 may be movably coupled to the keyboard housing 1002 via a ball bearing rail system 1006. The ball bearing rail system 1006 may be identical to the ball bearing rail system 106 described above and illustrated in FIGS. 1-6. For example, the ball bearing rail system 1006 may include an outer rail and an inner rail that are movably coupled together via ball bearings on opposite sides.

In one example, the electronic device 1000 may include a latch 1010. The electronic device 1000 may include a pair of latches 1010 located on opposite ends of a front bezel 1016. The latch 1010 may be identical to the latch 110 described above and illustrated in FIGS. 1 and 7-9.

In one example, the slidable keyboard 1004 may be moved via the ball bearing rail system 1006 into an open position as shown in FIG. 10. When the slidable keyboard 1004 is in the open position, upgradeable electrical components 1012₁ to 1012ₙ (also hereinafter referred to individually as an upgradeable electrical component 1012 or collectively as upgradeable electrical components 1012) may be accessed. In one example, the upgradeable electrical components 1012 may include random access memory (RAM), a solid state hard disk drive, and the like, that are removably coupled to a motherboard 1008.

In one example, the housing 1002 may also include a compartment 1018 that includes electrical components 1014₁-1014ₘ (also hereinafter referred to individually as an electrical component 1014 or collectively as electrical components 1014). The electrical components 1014 may be inaccessible even when the slidable keyboard 1004 is in the open position. The electrical components 1014 may be non-upgradeable electrical components that may include fragile components that can be easily damaged (e.g., graphical processing units (GPUs) with fragile heat sink fins, the main processor, and the like).

In one example, the motherboard 1008 can accommodate the open position of the slidable keyboard 1004. For example, the motherboard 1008 may locate the upgradable electrical components 1012 in a middle area. The middle area may have dimensions that are approximately equal to an area that is exposed when the slidable keyboard 1004 is in the open position.

In addition, the connections and/or interfaces to connect the upgradeable electrical components 1012 to the motherboard 1008 may be arranged along a horizontal line. Thus, the motherboard 1008 may ensure that the upgradeable electrical components 1012 are within an accessible area when the slidable keyboard 1004 is opened. In addition, the motherboard 1008 may ensure that the electrical components 1014 are in an inaccessible area when the slidable keyboard 1004 is opened.

Thus, the electronic device and the associated housing for the electronic device provides a ball bearing rail system and latch that allow a slidable keyboard to open and close. The latch may ensure that the slidable keyboard remains locked in a closed position. The ball bearing rail system may provide a smooth and wobble free movement of the slidable keyboard. When the slidable keyboard is in the open position, easy access to upgradeable electrical components may be provided.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An electronic device, comprising:
a housing;
a slidable keyboard movably attached to the housing via a ball bearing rail system;
a mechanical stop coupled to the ball bearing rail system to control a distance that the slidable keyboard can open to access an electrical component; and
a latch coupled to the slidable keyboard to engage a member in the housing when the slidable keyboard is in a closed position to lock the slidable keyboard in the closed position.

2. The electronic device of claim 1, wherein the electrical component comprises an upgradeable electrical component.

3. The electronic device of claim 1, wherein the ball bearing rail system comprises:
an outer rail;
an inner rail;
a first ball bearing movably enclosed by a left wall of the outer rail and a left wall of the inner rail; and
a second ball bearing movably enclosed by a right wall of the outer rail and a right wall of the inner rail.

4. The electronic device of claim 3, wherein the outer rail is coupled to the housing and the inner rail is coupled to the slidable keyboard.

5. The electronic device of claim 3, wherein mechanical stop comprises a raised portion inside of the outer rail that engages an opening in the inner rail.

6. The electronic device of claim 1, wherein the electrical component is arranged in a horizontal line within an area that is approximately equal to a size of an opening formed when the slidable keyboard is in an open position.

7. The electronic device of claim 1, wherein the latch is located on a front bezel of the slidable keyboard.

8. The electronic device of claim 1, further comprising:
a compartment to block access to a second electrical component when the slidable keyboard is in an open position.

9. A housing for an electronic device, comprising:
a first outer rail and a second outer rail coupled to an inside bottom surface of the housing;
a first inner rail movably coupled to the first outer rail and a second inner rail movably coupled to the second outer rail, wherein the first inner rail and the second outer rail are coupled to a slidable keyboard; and
a latch coupled to a front bezel of the housing to lock the slidable keyboard into a closed position.

10. The housing of claim 9, wherein the first outer rail and the second outer rail are longer than the first inner rail and the second inner rail and the first outer rail and the second outer rail include a mechanical stop to limit a movement of the first inner rail against the first outer rail and the second inner rail against the second outer rail.

11. The housing of claim 9, wherein the latch is to move horizontally to engage or disengage from a fixed post inside of the housing and adjacent to the latch.

12. An electronic device, comprising:
a display housing; and
a keyboard housing coupled to the display housing, wherein the keyboard housing is to enclose an electrical motherboard that comprises non-upgradeable electrical components and upgradeable components, wherein the keyboard housing comprises:
a slidable keyboard movably attached to the keyboard housing via a ball bearing rail system, wherein the slidable keyboard is to slide into an open position when a latch on the slidable keyboard is moved into an open position and provide access to the upgradeable components.

13. The electronic device of claim 12, further comprising:
a compartment to store the non-upgradeable electrical components, wherein the slidable keyboard slides away from the compartment to slide into the open position.

14. The electronic device of claim 12, wherein the ball bearing rail system comprises:
an outer rail;
an inner rail;
a first ball bearing movably enclosed by a left wall of the outer rail and a left wall of the inner rail; and
a second ball bearing movably enclosed by a right wall of the outer rail and a right wall of the inner rail.

15. The electronic device of claim 12, wherein the latch comprises tensioned prongs that engage a member in the keyboard housing when the slidable keyboard is in a closed position.
